(19) United States
(12) Patent Application Publication
(10) Pub. No.: US 2003/0054949 A1
(43) Pub. Date: Mar. 20, 2003

(54) Immobilized metalchelate complexes for catalysis and decontamination of pesticides and chemical warfare nerve-agents

(76) Inventors: Eddie L. Chang, Silver Spring, MD (US); Alok Singh, Springfield, VA (US); Qin Lu, Alexandria, VA (US); Christopher Hartshorn, Delmar, NY (US)

Correspondence Address: NAVAL RESEARCH LABORATORY, ASSOCIATE COUNSEL (PATENTS), CODE 1008.2, 4555 OVERLOOK AVENUE, S.W., WASHINGTON, DC, 20375-5320, US

(21) Appl. No.: 09/862,418

(22) Filed: May 23, 2001

(51) Int. Cl. B01J 31/00

(52) U.S. Cl. 502/159; 502/162; 502/167

(57) ABSTRACT

The present invention relates to the preparation of metal chelate complexes immobilized on a support, immobilized metal chelate complexes and methods of using the supports and immobilized metal chelate complexes for the adsorption and/or hydrolysis of phosphate esters. More specifically, processes for the preparation of immobilized metal chelate complexes by attachment of metal chelate complexes to solids, polymers, micelles, liposomes, tubules and other self-organized polymolecular associations immobilized metal chelate complexes made by such processes and use of the supports and immobilized metal chelate complexes for the adsorption and/or hydrolysis of phosphate ester group containing compounds such as chemical warfare nerve agents and pesticides, are disclosed. The present invention provides the ability to efficiently decontaminate phosphate ester compounds under a wide range of conditions in a practical and cost-effective manner.

### BACKGROUND OF THE INVENTION

1. Field of the Invention

The present invention relates to the preparation of metal chelate complexes immobilized on a support, immobilized metal chelate complexes and methods of using the supports and immobilized metal chelate complexes for the adsorption and/or hydrolysis of phosphate esters. More specifically, the present invention relates to processes for the preparation of immobilized metal chelate complexes by attachment of metal chelate complexes to solids, polymers, micelles, liposomes, tubules and other self-organized polymolecular associations immobilized metal chelate complexes made by such processes and use of the supports and immobilized metal chelate complexes for the adsorption and/or hydrolysis of phosphate ester group containing compounds such as chemical warfare nerve agents and pesticides.

2. Description of the Related Art

The earliest chemical agent decontaminating agents were bleaching powders and other oxidizers as disclosed in Yang, Y. C. et al., J. Chem. Rev. 1992, vol. 92, pp. 1729-1743. However, bleaches have certain disadvantages: a) their activity decreases on storage; b) a large amount of bleach needs to be used; and c) bleaches are corrosive to many surfaces.

The present choice for decontamination solution is either DS-2 or STB (super tropical bleach). DS-2 is a non-aqueous liquid composed of diethylenetriamine, ethylene glycol, monomethyl ether, and sodium hydroxide. Although DS-2 is generally not corrosive to metal surfaces, it damages skin, paints, plastics, rubber, and leather materials. STB, while effective, still has the same environmental problems as bleaches and cannot be used on the skin.

Personal decontamination equipment generally consists of packets of wipes containing such chemicals as sodium hydroxide, ethanol, and phenol. These chemicals are selected to provide a nucleophilic attack at the phosphorous atom of nerve agents.

Alternative methods of decontamination have focused on the development of processes for the catalytic destruction of nerve agents and pesticides. It was first recognized in the 1950's that certain metal ions, especially Cu(II), had the ability to catalyze the hydrolysis of nerve agents and their simulants. Exemplary publications relating to these developments include Wagner-Jauregg et al., J. Am. Chem. Soc. 1955, vol. 77, pp. 922-929; Courtney, R. C. et al., J. Am. Chem. Soc., 1957, vol. 79, pp. 3030-3036; Gustafson, R. L. and Martell, A. E., J. Am. Chem. Soc., 1963, vol. 85, pp. 598-601; LeJeune, K. E. et al., Biotechnology and Bioengineering, 1997, vol. 54, pp. 105-114; and Smolen, J. M. and Stone, A. T., Environ. Sci. Technol., 1997, vol. 31, pp. 1664-1673. The catalytic activity of such chemicals was significantly enhanced when Cu(II) was bound to certain ligands. For example, diisopropyl phosphorofluoridate (DFP) has a hydrolytic half-life of approximately 2 days in water, 5 hours in water when CuSO₄ is added, and just 8 minutes in water when Cu(II) bound to either histidine or N,N′-dipyridyl is added in an approximately 2:1 ratio of metal complex to substrate. Sarin was found to be even more susceptible to metal-based catalysis with a half-life of only 1 minute in the presence of tetramethyl-EDA-Cu(II) complex (1:1 metal complex to substrate).

In general, the catalytic activity of the metal ions increases with pH and chelate concentration. Bidentate ligands are more effective with copper than multi-dentate ligands, and the lower the stability of the metal-chelate complex, the more effective the catalysis of the degradation of the nerve agents. An added advantage of catalysis using metal-chelate complexes is that the complexes are not limited by their solubility to being used in only acidic environments, but rather can function across a wide pH range—depending upon the solubility of the metal ion of the catalyst. Monodentate ligands were found to be generally effective for the catalysis of the degradation of nerve agents due to the instability of their 1:1 Cu(II) complexes at pH 7. See Wagner-Jauregg et al., J. Am. Chem. Soc. 1955, vol. 77, pp. 922-929.

Use of free copper-ligand complexes for catalyzing the degradation of nerve agents also has disadvantages. First, the nerve agent must be brought into contact with a solution of the metal ion containing catalyst. Second, the ratio of metal to chelate must be carefully controlled. Third, solubility issues can still limit the pH range and choice of chelates for use in a particular environment.

More recently, researchers have begun to look at enzymes stabilized by attachment to polymeric support as catalysts for the degradation of nerve agents. These enzymes, variously known as organophosphorous acid anhydrases, phosphotriesterases, sarinase, or others, are extracted either from microorganisms, such as Pseudomonas diminuta, or from squid. The enzymatic approach shows promise but is limited by the specificity of the proteins for their substrates, e.g. a parathion hydrolase would not be effective against another nerve agent, and because the enzymes require a very specific range of conditions, e.g., pH, to function properly. In addition, field conditions can involve concentrated solutions of nerve agents, which can overwhelm the relatively low concentration of enzymes which can be immobilized on a support.

### DETAILED DESCRIPTION OF THE PREFERRED EMBODIMENTS

In a first aspect, the present invention relates to processes for the preparation of immobilized metal chelate complexes. In accordance with the invention, metal chelate complexes can be immobilized on a variety of different supports. Thus, the processes for the preparation of immobilized metal chelate complexes may involve attachment of the metal chelate complexes to solids, polymers, micelles, tubules and other self-organized polymer associations.

In general terms, the metal chelate complexes may be attached to the support in a variety of different ways. For example, the chelates can be chemically reacted with the support, can be coupled to long chain hydrocarbons or be substituted with a polymerizable group such as a vinyl group or reacted with an acrylate monomer that can be used to produce polymers containing the chelate. Also, chelate-containing monomers can be templated with a metal ion and then used to form polymers containing a metal chelate complex.

One category of processes in accordance with the invention provides for the immobilization of metal chelate complexes on solid supports such as silica or chitosan. A second category of processes in accordance with the invention involves the formation of suspensions of micelles, liposomes, tubules or other self-organized polymer associations having catalytically active metal chelate complexes on their surface. A third category of processes in accordance with the invention attaches chelates and/or metal chelate complexes to a polymeric support all categories of processes in accordance with the invention provide a metal chelate complex which is covalently bound to the support.

The chelates employed in the present invention can either be in their unmodified form, e.g., ethylenediamine (EDA), diethylenetriamine (DETA), histidine and histamine; be coupled to long-chain hydrocarbons, e.g., hexadecyl bromide, or be substituted with a polymerizable group that can be cross-linked with matrix forming monomers to yield cross-linked polymers, e.g., N¹-[3-(trimethoxysilyl)propyl]ethylenediamine (EDA-silane), N¹-[3-(trimethoxysilyl)propyl]diethlylenetriamine (DETA-silane), -[4-(vinyl)benzyl ethylenediamine] (VBEDA), -[4-(vinyl)benzyl diethlylenetriamine (VBDETA), 4-vinyl-4-methyl-2,2′-bipyridine, and acrylate monomer forms of chelates.

Unmodified chelates that have at least one primary amino group can be reacted with isocyanate groups to form polyurethanes. For example, a polyurethane prepolymer, such as PREPOL from Lendell Manufacturing, can be mixed directly an amino-group containing chelate, or can be mixed with an amino group containing chelate in a minor amount of a solvent such as water, aprotic solvents, or alcohols and reacted to form a chelate-containing polymer. Carrying out the reaction between the amino group and the isocyanate in the presence of water results in the formation of a polymeric foam, while carrying out the reaction in the presence of one of the non-aqueous solvents results in a more rubber-like material. This process is exemplified in greater detail in Examples 1-2.

Silylated chelates can be covalently bonded to silica gel by standard techniques to produce a catalytic powder. The activity of the catalytic powder will be affected by the ratio of silylated chelates to silica gel which is employed in the process for the preparation of the catalytic powder. This process is exemplified in Example 3. Silylated chelates can be prepared using commercially available silica gels or specially prepared mesoporous silica.

Also, chelates having epoxide groups, acrylate groups or vinyl groups can be employed.

Chelating amphiphiles, such as EDA or iminodiacetate lipids, can optionally be made into phospholipids. For example, according to published procedures: metal chelating phospholipid, 1,2-bis(tricosa-10,12-diynoyl)-rac-glycero-3-phospho-N-(2-ethyl)-iminodiacetic acid, its dipalmitoyl analogue, and their intermediates can be synthesized by a known synthetic route with some minor modifications. An example of this process is given below in Example 4. Metal ions such as Cu(II), Zn(II), Co(III), Fe(III), Pb(III), Mg(II), Mn(III), Ni(III), La(III), Ce(III), and Eu(III) can be complexed to the iminodiacetic acid head group either before or after liposome/micelle formation. The obtained suspension of metal chelate complex-containing liposomes/micelles can be used as a very high surface area treatment for the hydrolysis of phosphate esters.

Particularly preferred complexing agents or chelating agents are bipyridines, terpyridines, and related chelating agents such as 4-vinyl-4′methyl-2,2′-bipyridine, cyclic chelating agents such as 1,4,7-triazacyclononane, 1,4,7,10-tetraazacyclododecane (cyclen), and acrylic chelating agents such as tris-(3-aminopropyl)amine and analogs and derivatives of these compounds which are known by persons skilled in the art to exhibit a suitable level of chelating activity.

Some exemplary binuclear chelates are shown below, some of which are functionalized with polymerizable groups and some of which are not.

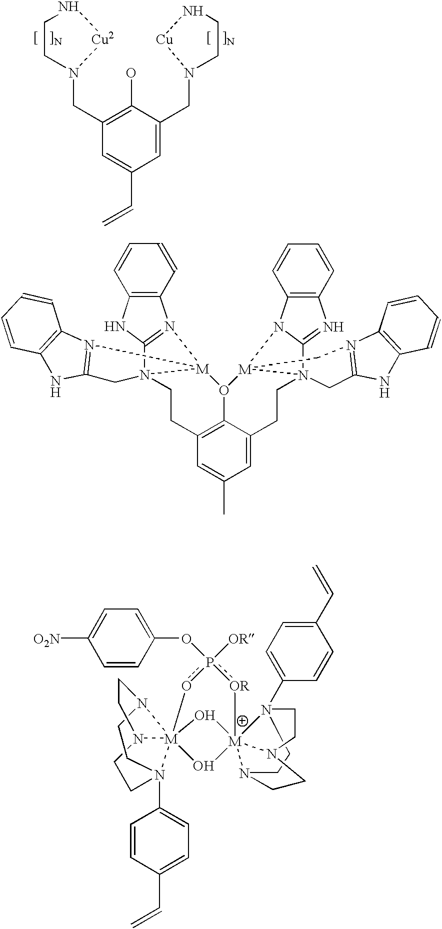

Vinylbenzene chelate-containing monomers can be templated with metal ions and cross-linked with various amounts of 2-ethyl-2(hydroxymethyl)propane-trimethyacrylate (TRIM) or other suitable cross-linking agents and divinyl benzene to form macroporous resins. An exemplary method is given in Example 5. Unlike, the previously described materials, the metal ions are already incorporated into the polymer during cross-linking and thus the obtained cross-linked polymer is ready for use as a catalyst for the degradation of nerve agents and/or pesticides.

Other suitable cross-linking agents include, but are not limited to, acrylic acid, methacrylic acid, trifluoro-methacrylic acid, 2-vinylpyridine, 4-vinylpyridine, 3(5)-vinylpyridine, p-methylbenzoic acid, itaconic acid, 1-vinylimidazole, and mixtures thereof.

A similar procedure may be used for polymerization of the acrylate monomers as for the vinylbenzene monomers: the acrylate monomers are mixed with a minimum amount of tetrahydrofuran or toluene, an initiator such as AIBN is added, and the solution is heated. After polymerization is complete, the product is contacted with a highly concentrated solution of metal ion, the excess metal ion is washed off, and the resulting polymer is ready to be used as a catalyst for the hydrolysis of phosphate esters.

Various methods for the attachment of metal chelate complexes to various supports have been described to produce immobilized metal chelate complexes useful for catalyzing the hydrolysis of phosphate esters.

The invention also includes methods for the production of macroporous materials that have a specific affinity for a metal ion as a result of templating the support with the metal ion. Templating is a conventional process known to persons skilled in the art. However, the application of templating in the processes of the present invention is considered to be novel and advantageous. More specifically, in the case of polymeric materials, the chelate-containing monomer can be contacted with metal ion prior to polymerization to template the monomer with the metal ion. As a result, the metal ion is carried over from the monomer into the polymer during the polymerization step to provide a polymer containing reactive sites with the metal ion.

In a second aspect, the present invention relates to immobilized metal chelate complexes which can be made by one or more of the processes of the present invention. There are several advantages to the use of immobilized metal chelate complexes over both the use of solutions of metal chelate complexes and over the use of immobilized enzymes for the same purpose. Immobilization of metal chelate complexes in accordance with the present invention allows the operation of the desired hydrolysis reaction in a much wider pH range than the use of metal complexes in solution due to solubility issues, particularly at higher pH. Immobilization of the metal chelate complex on a support also permits the use of metal chelate complexes, such as those based on monodentate chelates, which would otherwise be unsuitable for use in the hydrolysis of phosphate esters due to their low reactivity. For example, it is possible to attach metal ion complexes with monodentate chelates to silica and use the resultant product in a hydrolysis reaction at high pH in accordance with the present invention.

As compared to immobilized enzymatic systems, the present invention is generic in that it can be employed to hydrolyze any phosphoro- or phosphono-group containing pesticide and/or nerve agent, while enzymes are specific only to one, or to a limited number of pesticides or nerve agents, Second, the system of the present invention works well over a large pH range and, in fact, functions even better than conventional enzymatic systems at basic pH. Third, the small molecular size of the immobilized metal chelate complexes of the present invention enables hydrolysis reactions to occur even if there is an overwhelming overabundance of pesticide or nerve agent relative to the immobilized metal chelate complexes whereas enzymatic systems do not function well under such conditions. Finally, the materials for the system of the present invention are cost-effective and are currently available in commercial quantities. That is, both the low cost and the potential for manufacturing these immobilized metal chelate complexes in large quantities make it conceivable, were the need to arise, to supply the entire population of the United States with personal decontamination kits based on the system of the present invention. Also important is that the materials of the present invention act as a catalyst and thus large quantities of harmful compounds can be hydrolyzed by a small amount of the materials of the present invention.

There are additional applications for the immobilized metal complexes of the present invention beyond their use to decontaminate areas contaminated with nerve agents and/or pesticides. For example, the catalytic hydrolysis of nerve agents and/or pesticides using the immobilized metal chelate complexes of the present invention can be employed as the operative process step in a detector system wherein the by-products of the hydrolysis reaction, such as hydrogen fluoride, for example, may be subject to measurement to provide an indication of the presence and/or concentration of a particular phosphate ester in the environment.

Another aspect of the invention relates to the selection and/or preparation of the support on which a metal chelate complex may be immobilized. More particularly, in a preferred embodiment of the invention, the support is capable of adsorbing one or more of the phosphate esters which are to be hydrolyzed. It has been found that hydrolysis rates can be substantially increased by employing supports capable of adsorbing the material to be hydrolyzed. Typical phosphate esters which can be hydrolyzed by the compositions and methods of the present invention are phosphates, phosphorofluoridates, phosphonates, and their sulfur analogs such as phosphorothionates.

In addition, the use of adsorbent supports provides greater flexibility in the process of decontamination since a variety of options for decontamination are made available by selecting an adsorbent support. For example, sufficient immobilized metal chelate complex can be employed to completely hydrolyze the phosphate ester in situ as described above whereby the hydrolysis is carried out at the site of the contamination. Alternatively, decontamination can be accomplished by hydrolyzing only a portion of the hazardous material at the site of the contamination and adsorbing the remaining un-hydrolyzed material onto the support. Optionally, further metal chelate complex can be added to the support containing the adsorbed material at a later time or different location to complete the hydrolysis, or the support can be disposed of in a suitable manner without completing the hydrolysis. Also, support without metal chelate complex can be initially employed to adsorb the phosphate triester at the location of the contamination and subsequently the support can be treated with catalytically active metal ions, i.e. in solution, to hydrolyze the phosphate ester, if desired.

Particularly advantageous polymeric supports that adsorb phosphate esters can be prepared by imprinting the polymeric substrate with the species of interest. Imprinting is a conventional process known to persons skilled in the art. However, it has been found that imprinting the polymeric supports of the present invention for a phosphate ester provides a significant increase in the amount of the phosphate ester which may be adsorbed onto the support. Imprinting may be accomplished by carrying out the polymerization step used to make the immobilized metal chelate complex or support in the presence of a phosphate ester or a transition state analog of a phosphate ester. Imprinting is exemplified below in Example 16.

The adsorbent supports and the immobilized metal chelate complexes may be fabricated in the form of filters, sponges, wipes, powder or any other physical form suitable for use in the decontamination process.

Particularly preferred immobilized metal chelate complexes are exemplified in Examples 15-20. The metal chelate containing polymeric materials of Examples 15-17 were made by polymerizing copper(II) nitrate hemipentahydrate, 4-vinyl-4′-methyl-2,2′-bipyridine and TRIM. In Example 16, the polymer was imprinted with BNPP during the polymerization step to significantly enhance the ability of the polymer to adsorb BNPP. These preferred complexes provided improved hydrolysis rates as compared to conventional materials used to hydrolyze phosphate esters.

The supports and immobilized metal chelate complexes of the present invention can be use in processes for the decontamination of chemical warfare nerve agents and pesticides. The metal chelate complexes will hydrolyze materials which contain either a phosphono-group or a phosphoro-group. The supports can selected or synthesized to adsorb phosphate esters. One or both of the hydrolysis and adsorption can be employed in particular decontamination process depending upon the particular needs at the location of the decontamination.

Decontamination is accomplished simply by contacting the support and/or immobilized metal chelate complex with the phosphate ester to adsorb and/or hydrolyze it. If a step of adsorption without hydrolysis is desired for a particular decontamination process, then a sufficient amount of the support should be employed to adsorb substantially all of the phosphate ester. The proper amount of adsorbent support to be used in a particular cleanup can be determined by routine experimentation using the methodology set forth in Examples 15-17 of the present application.

If in situ hydrolysis of the phosphate ester is to be carried out, then the amount of immobilized metal chelate complex employed will depend on the degree of hydrolysis desired. Thus, if complete hydrolysis is desired, then sufficient immobilized metal chelate complex should be employed to accomplish the complete hydrolysis in a reasonable time period. If partial hydrolysis is desired, then the immobilized metal chelate complex should be immobilized on an adsorbent support such that both hydrolysis and adsorption occur. The degree of hydrolysis depends on the interaction of the catalytically active metal ions and the phosphate ester. Thus, the greater the area of contact between the two, the greater the degree of hydrolysis which will be achieved in a specified time period.

The invention will now be illustrated in greater detail using the following examples.

### EXAMPLES OF THE PREPARATION OF IMMOBILIZED METAL CHELATE COMPLEX

### Example 1

A polyurethane prepolymer, in this case PREPOL from Lendell Manufacturing, was mixed directly with an amino group-containing chelate and reacted to form a chelate-containing polymer. The mixture was stirred vigorously to allow the amino groups to react with the isocyanate groups. The resulting polymer was washed thoroughly with water and contacted with a highly concentrated solution of Cu(II) ions; the excess metal ions were washed away and the resultant metallated polymer was ready to be used as a catalytic polymer.

### Example 2

The procedure of Example 1 was followed except that the PREPOL was mixed with an amino-group containing chelate in the presence of a minor amount of water as a solvent. The presence of water during the reaction between the amino groups and the isocyanate groups resulted in the formation of polymeric foam. The resultant polymer was washed thoroughly with water and contacted with a highly concentrated solution of Cu(II) ions; the excess metal ions were washed away and the resultant metallated polymer was ready to be used as a catalytic polymer.

### Example 3

A suspension of silica and technical grade EDA-silane was refluxed for 20 to 24 hours in toluene, the suspension was filtered, and the silica was washed with methanol. The modified silica was heat treated at 70-90° C. for 3 to 24 hours to produce a bonded silica. The resulting bonded silica was contacted with a highly concentrated solution of Cu(II) ions; the excess metal ions were washed away and the obtained metallated silica gel was ready to be used as a catalytic powder.

### Example 4

Rac-glycero-3-phospho-N-(2-ethyl)-iminodiacetic acid was reacted with acid anhydride in the presence of 4-dimethylaminopyridine (DMAP) with the aid of ultrasound agitation for 2 hours followed by overnight stirring. After the reaction was complete, chloroform was evaporated under reduced pressure and the residue was dissolved in chloroform:methanol (1:1) and passed through a cation exchange column to remove DMAP and cationic impurities. Lipid from the mixture was separated by flash chromatography using chloroform, 5% methanol/chloroform, and then a 10% methanol/chloroform as eluants. The obtained phospholipids have Rfs between 0.45-0.50 in a chloroform/methanol/water (65/25/4) solvent system.

Cu(II) ions were then complexed to the iminodiacetic acid head group. The obtained suspension of metal chelate complex-containing liposomes/micelles can be used as a very high surface area treatment for the hydrolysis of nerve agents and pesticides.

### Example 5

A substituted polyamine was mixed with CuX₂ (X=ClO₄—, Cl—) in a molar ratio of 1:1 in ethanol, and the mixture was stirred at room temperature. TRIM in ethanol was added to the polymer solution, and the polymerization was initiated with 2,2 azo-bisisobutyronitrile (AIBN). After polymer formation, the resultant polymer was filtered and washed with solvents to remove unreacted starting materials. The obtained polymer was suitable for use as a catalyst for the hydrolysis of nerve agents and pesticides.

### EXAMPLES OF THE HYDROLYSIS OF PHOSPHONATE TRIESTERS

### Examples 6-12 and Comparative Examples A-C

Several immobilized metal chelate-containing materials prepared in accordance with the procedures detailed in Examples 1-5 were tested on a selected target substrate to determine the reactivity of the different materials. The kinetics of the reaction were examined at a relatively high pH (pH 8.2), at which the metal ion solubility often becomes a problem for many conventional metal chelate complexes used for this purpose.

Methyl parathion (MeP, C₈H₁₀NO₅PS), a phosphorothionate ester, is the second most common pesticide used in the United States. In the following examples, MeP was hydrolyzed in the presence of several immobilized metal chelate complexes in accordance with the present invention. The concentration of one hydrolytic product, nitrophenol, of the hydrolysis of methyl parathion was used to monitor reaction progress. As such, some of the experimental conditions are specific to the system discussed and are not meant to limit the conditions under which catalytic hydrolysis in accordance with the present invention may be carried out. For other systems, such as those employing fluoridated compounds, pH-stasis can be used to determine reaction kinetics instead of monitoring the concentration of one of the hydrolysis products.

In order to ensure that the enhanced rates that were observed were due to catalytic activity, the reaction was carried out using a 1:3 ratio of immobilized EDA/Cu(II): MeP (7.4×10⁻⁴ mmol of EDA/Cu(II): 2.22×10⁻³ mmol of MeP). After 24 hours, it was observed that 1.1×10⁻³ mmol of MeP was hydrolyzed by the reaction carried out in the presence of the immobilized EDA/Cu(II), whereas only 2×10⁻⁴ mmol of MeP were hydrolyzed in the control reaction.

Preliminary experiments were performed to determine whether there is an enhanced hydrolysis reaction in the presence of the immobilized metal chelate complexes and to estimate the increased reaction rates. Thionate esters are known to hydrolyze more slowly than the corresponding oxonate esters, which, in turn, hydrolyze more slowly than the corresponding fluoridates. Therefore, the half-lives for the hydrolysis of the more active phosphate esters should be much shorter for these reasons. For example, it has been reported that MeP can be slowly hydrolyzed by aqueous Cu(II) with a half-life of about 90 hours at pH 7 at low ionic strength, (Smolen, J. M. and Stone, A. T., Environ. Sci. Technol., 1997, vol. 31, pp. 1664-1673) while diisopropyl phosphorofluoridate (DFP) has a half-life of only about 6 hours under similar hydrolysis conditions (Wagner-Jauregg et al., J. Am. Chem. Soc. 1955, vol. 77, pp. 922-929).

Below in Table 1 are given some initial estimates of the half-lives of MeP under hydrolysis conditions with different immobilized metal chelate complexes at high ionic strength (0.1 M carbonate). Since most of the reactions yielded linear graphs of product vs. time over several hours, first-order kinetics analysis was employed for a convenient estimation of the half lives without assuming, a priori, that the reactions are first-order. Concentration curves were calibrated using the nitrophenol absorption peak at 400 nm.

TABLE 1
Hydrolysis, t½, of MeP at pH 8.2

| Example | Chelate (chelate:silica) | t½(min) |
|---|---|---|
| A | — (water) | 2.5 × 10 ⁵ |
| B | — (Cu(II)aq) | 3.2 × 10⁴ |
| 6 | EDA (1:4) | 2.6 × 10⁴ |
| 7 | EDA (1:20) | 3.1 × 10³ |
| 8 | EDA (1:40) | 3.1 × 10² |
| 9 | amino propyl silane (1:4) | 4.8 × 10² |
| C | EDA:Cu(II)aq | 2.2 × 10² |
| 10 | EDA polymer (10%) | 3.5 × 10² |
| 11 | Polyurethane (20% EDA) | 1.1 × 10³ |
| 12 | Polyurethane (20% DETA)* | 1.1 × 10³ |

*DETA is diethylene triamine.

By comparison with the free (aqueous form) metal chelate t 1/2 it is apparent that immmobilized metal chelate complexes in accordance with the present invention can be formulated to achieve hydrolysis reaction rates comparable to the maximum reaction rates achievable using a non-immobilized metal chelate complex. It is also seen that immobilization of a metal chelate complex based on amino propyl silane, a monodentate ligand, allowed use of this system at pH 8.2 without risk of precipitation. Since the phosphates of DFP and sarin are much more active towards hydrolysis than the phosphorothionates tested in these examples, it is expected that under hydrolysis conditions similar to those employed in the present examples, half-life times for sarin hydrolysis could be on the order of minutes.

### Examples 13-14 and Comparative Examples D-J

Cu(II)-containing polymers are made by incorporating Cu(II) complexes of L1-L3 into trimethylolpropane trimethacrylate (TRIM) matrix.

CuCl₂.2H₂O, KCl, TRIM, and CO₂-free Dilut-it ampoules of KOH were obtained from Sigma Chemical Co., Fisher Scientific Co., TCI, and J. T. Baler Inc., respectively. All other chemicals including ethylenediamine, diethylenetriamine, 4-vinylbenzyl chloride, and 4-nitrophenyl phosphate were purchased from Aldrich Chemical Co.

N-(4-vinyl)benzyl Ethylenediamine (L1).

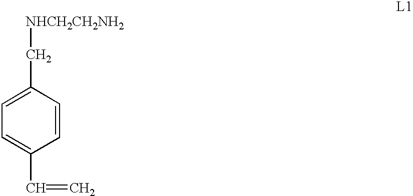

A solution of 4-vinylbenzyl chloride (1.52 g, 10 mmol) in dichloromethane (100 ml) was added dropwise to a stirred solution of ethylenediamine (2.4 g, 40 mmol) in dichloromethane (200 ml). The resulting mixture was stirred at room temperature for 4 hours. Solvent was then removed on a rotary evaporator. The residue was purified by chromatography on silica gel (9/1 MeOH/NH₄OH) to give N-(4-vinyl)benzyl ethylenediamine as a brown oil (0.88 g, 50%).The structure of the N-(4-vinyl )benzyl ethylenediamine was confirmed by HNMR analysis.

1-(4-vinyl) Benzyl Diethylenetriamine (L2) and 4-(4-vinyl) Benzyl Ditheylenetriamine (L3).

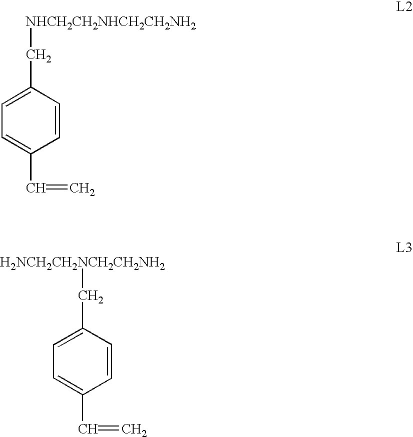

A solution of 4-vinylbenzyl chloride (1.52 g, 10 mmol) in dichloromethane (100 ml) was added dropwise to a stirred solution of diethylenetriamine (4.12 g, 40 mmol) in dichloromethane (300 ml). The resulting mixture was stirred at room temperature for 4 h. Two mono-substituted isomers were separated by chromatography on silica gel (9/1 MeOH/NH₄OH), 1-(4-vinyl) benzyl diethylenetriamine trihydrochloride and 4-(4-vinyl) benzyl diethylentriamine trihydrochloride. The structure of these isomers was confirmed by HNMR analysis.

Preparation of Cross-Linked Polymers from Cu(II) Complexes of L1-L3 and TRIM

The following procedures were followed in the preparation of cross-linked polymers Poly1, Poly2, and Poly3 from the Cu(II) complexes of L1-L3, respectively, and TRIM. One mmol of substituted polyamine was mixed with CuX₂ (X=ClO₄ for L1, NO₃ for L2-L3) in a molar ratio of 1:1 or 2:1 in 25 ml EtOH. The mixture was stirred at room temperature for 15 minutes before 9 mmol TRIM in 10 ml EtOH was added. The resulting solution was heated to 70° C. while bubbling nitrogen through the solution. 100 mg initiator 2,2-azobisisobutyronitrile (AIBN) was then added to start the polymerization. Polymer formation could be seen within an hour. Polymers containing 10 mol % metal ion content relative toTRIM were isolated by filtration and washed with solvents to remove unreacted starting materials.

Metal-free cross-linked polymers made from L1-L3 and TRIM were also synthesized by the same procedures as in Examples 13-14 except without adding the Cu(II) salt.

Experimental Methods

¹H and ¹³C spectra were recorded on a Bruker AVANCE DRX 400 spectrometer. UV-VIS spectra were recorded on a Varian CARY 2400 spectrophotometer.

All pH calibrations were performed with standard dilute strong acid at 0.1 M ionic strength in order to measure hydrogen ion concentration directly. Thus p[H] is defined as −log[H⁺].

Potentiometric studies of N-(4-vinyl)benzyl ethylenediamine dihydrochloride, 1-(4-vinyl)benzyl diethylenetriamine trihydrochloride, and 4-(4-vinyl)benzyl diethylenetriamine trihydrochloride in the absence and presence of metal ions were carried out with an Orion model 920A pH meter fitted with an Orion combined electrode. Each titration in aqueous solution was performed at 25.0° C. and under anaerobic conditions. The concentrations of the experimental solutions were approximately 2×10⁻³ to 4×10⁻³ M. The stoichiometries of ligand-metal ion systems are 1:1 and 2:1. Equilibrium constants were calculated with the program BEST. The log K_{w} for the system, defined in terms of log [H⁺][OH⁻], was found to be −13.78 at the ionic strength employed and was maintained fixed during the refinement. In all the potentiometric determinations the s_{fit}, which measures the deviation of the experimental curve and the curve 20 calculated from the equilibrium constants, was less than 0.02 [pH] unit. More details on these methods can be found in Martell, A. E. and Motekaitis, R. J., Determination and Use of Stability Constants, VCH, New York, 2^{nd} edition, 1992.

The method of initial rate was used to determine the rate constants of 4-nitrophenyl phosphate hydrolysis in the presence of Poly1, Poly2, and Poly3. In a typical experimental run, 10 ml borate buffer (pH=8.5) containing substrate (in the range of 10⁻⁴-10⁻³ M ) was capped in a 15 ml test tube and placed in a thermostated bath (55±0.5° C.) equipped with a shaker. The reaction was initiated by adding 0.05 g Cu(II)-containing cross-linked polymer (˜10⁻⁵ mol of Cu(II) ion). Periodically, 0.2 ml solution was taken out by a syringe and diluted to 1 ml with borate buffer in a cuvette. The hydrolysis of 4-nitrophenyl phosphate was then followed through UV absorbance of 4-nitrophenylate at 400 nm. A control solution was prepared in a similar way except in the absence of Cu-containing polymer in order to be able to eliminate the effect from the spontaneous hydrolysis of 4-nitrophenyl phosphate. The initial rate of the reaction was obtained from the plot of 4-nitrophenyl phosphate concentration (calculated from the extinction coefficient of 4-nitrophenylate, 18700 L mol⁻¹) versus time. All the measurements were done in duplicate and the reactions were followed for less than 5% hydrolysis of the substrate. For the purpose of comparison, the kinetics of monomeric Cu(II) complexes of L1, L2, L3 and the metal-free cross-linked polymers have also been also carried out under the same conditions.

The rates of 4-nitrophenyl phosphate hydrolysis in the presence of either Cu(II) complexes of L1-L3 or Cu(II)-containing cross-linked polymers, Poly1-Poly3, and the metal-free cross-linked polymers have been measured by UV-VIS spectrometer at 55° C. and pH 8.5. Since each measurement was carried out relative to a reference solution containing the same buffer and prepared under the same conditions as for the sample solution, the catalytic contribution, if any, from the hydroxide or buffer may be ignored.

Kinetic studies show that the Cu(II)-containing cross-linked polymers made by incorporating [Cu(L1)₂]X₂ and [CuL3]X₂ catalyze the hydrolysis of 4-nitrophenyl phosphate with first order rate constants 1.33×10⁻⁵ and 1.04×10⁻⁶ s⁻¹, respectively, at 55 C and pH 8.5. An often-overlooked additional advantage of incorporating the monomeric metal complexes into a polymeric matrix is that the polymeric structure may confer catalytic reactivity to metal complexes which would otherwise exhibit poor reactivity under the same reaction conditions.

Of all the kinetic measurements taken, only Poly1 and Poly3 show observable reactivity with approximate first order rate constants of 1.33×10⁻⁵ and 1.04×10⁻⁶ s⁻¹, respectively (the k_{obs.} of uncatalyzed hydrolysis of 4-nitrophenyl phosphate at 55° C. and pH 8.36 is 4.7×10⁻⁷ s⁻¹). The reactions are catalytic as judged by the amount of 4-nitrophenylate produced under the conditions of a large excess of substrate. Because some adsorption of the nitrophenylate product ion by the polymers was observed, the above rate constants are likely a lower bound on the actual values. In either case, the adsorption did not appear to poison the catalytic centers within the polymers. All other complexes showed no measurable rate enhancement over the spontaneous hydrolysis of 4-nitrophenyl phosphate under the same conditions.

The inability of the monomeric Cu(II) complexes of L1-L3 to catalyze the hydrolysis of 4-nitrophenyl phosphate is not surprising. The catalytic reactivity of Cu (II) ion for the hydrolysis decreases with increasing stability constants of the complexes. All three Cu(II) complexes have relative high stability constants, indicating that the Cu(II) ions in the complexes are poor Lewis acids which only react weakly with the substrate. The Cu(II)-containing cross-linked polymers Poly1 and Poly3, contrary to the monomers, do exhibit catalytic reactivity in the hydrolysis of 4-nitrophenyl phosphate.

Three conclusions may be drawn from above results. First, the presence of Cu(II) ion is a necessary requirement for the observed catalytic reactivity since the metal-free cross-linked polymers show no activity. Second, the cross-linked polymer structure confers catalytic reactivity to some otherwise non-reactive Cu(II) centers, coordinated either by two molecules of L1 or by one molecule of L3. Finally, the copper-containing polymers increase the apparent first order rate-constants by over an order of magnitude.

### Examples 15-16

Preparation of Chelator-Metal Complexes

Copper(II) nitrate hemipentahydrate (1 equiv.), 4-vinyl-4-methyl-2-2′-bipyridine (1 equiv.) and trimethylolpropane trimethacrylate (10 equiv.) were stirred in ethanol at 70° for 30 minutes while argon was bubbled through the solution. 2,2′-Azobisisobutyronitrile (0.1 equiv.) was added and stirring continued under the same conditions for a further 90 minutes. Over this time pale blue polymer precipitated from the reaction mixture. The solution was cooled and filtered to give the metal chelate complex-containing polymer.

The same reaction conditions were used for a second polymerization, but in the presence of bis-nitrophenylphosphate (1 equiv.) to give as polymer imprinted for hydrolysis of bis-nitrophenylphosphate (BNPP).

Hydrolysis of Phosphonate Triesters

Polymers prepared as described above were tested for hydrolysis of or methyl parathion, (MeP), a phosphorothionate ester. Kinetics were followed in 15% MeOH, 0.100 M MOPS, at pH 8.5. The hydrolytic product nitrophenol was used to monitor reaction progress.

The initial rates of hydrolysis were measure and both k_{cat}, the observed pseudo first-order rate constant, and Vₘₐₓ and Kₘ, the maximal velocity and the characteristic constant derived from a Michaelis-Menton kinetics model were calculated. From V_{mzx}, k_{cat}, the catalytic rate constant in s⁻¹ was obtained. The results are given in Table 2.

TABLE 2
Hydrolysis Rate as k_{cat}

| Substrate | Catalyst/Enzyme | Catalysis-Rate (s⁻¹) | Ratio k_{cat}/k_{uncat} |
|---|---|---|---|
| BNPP | (uncatalysed)^{a} | 1.1 × 10⁻¹¹ | — |
| BNPP | Bipyridyl:Cu (aq) | 1.5 × 10⁻⁶ | 1.3 × 10⁺⁵ |
| BNPP | Polymer:Cu (no BNPP | 2.4 × 10⁻⁵ | 2.2 × 10⁺⁶ |
| | templating) | | |
| MeP | (uncatalysed)^{b} | 8 × 10⁻⁷ | — |
| MeP | Cu^{b} | 3 × 10⁻⁵ | 38 |
| MeP | Bipyridyl:Cu (aq) | 1.4 × 10⁻³ | 1.7 × 10⁺³ |
| MeP | Polymer:Cu (no BNPP | 2.0 × 10⁻² | 2.5 × 10⁺⁴ |
| | templating) | | |
| MeP | Polymer:Cu (with | 2.6 × 10⁻² | 3.2 × 10⁺⁴ |
| | BNPP templating) | | |

^{a}Takasaki and Chin, J. Am. Chem. Soc. v. 117, 8582-8585 (1995)
^{b}Smolen and Stone, Environ. Sci. Technol., v.31, 1664-1673 (1997)

It is seen, from Table 2, that the polymeric metal chelate systems imprinted with BNPP are about 30% better for the hydrolysis of BNPP than those without imprinting and that hydrolysis in the presence of the imprinted polymers is 2.2×10⁶ and 3.2×10⁴ times more rapid than the uncatalyzed hydrolysis of BNPP and MeP, respectively. In comparison to the soluble metal chelate systems, the polymer systems are 16 times and 18 times more effective for hydrolysis, respectively.

It is surprising to find polymeric materials to be more efficient catalysts than their soluble counterparts, which presumably represent an optimized state. For example, one would expect that slight differences in coordination geometry, accessibility, and diffusion times would all contribute towards a decreased activity for the polymeric immobilized catalysts. Thus, chelator identity plays a crucial role in these polymer systems. But, in addition the supports themselves, both with and without the metal chelate centers, were found to be highly adsorbing for MeP and NPh, while BNPP bound strongly to the metallated polymers. This ability to adsorb substrate, thereby increasing the local substrate concentration, is another reason for the enhanced rates observed.

Polymer Binding Studies

The affinity of the polymers for the substrates, MeP and BNPP, and for the product, NPh, was determined by equilibrating known volumes of the substrate (or NPh) with known mass of polymer.

The amount adsorbed by the polymer was determined by measuring the concentration of solute remaining in solution (276 nm for MeP and 402 for NPh). Equilibrium constants were calculated for different models. It was found that the data fit best to:

Substrate+2Trim→(substrate TRIM₂)

From Table 3, its apparent that while NPh is recognized by the matrix polymer, a triester, such as MeP, is bound with hundreds of times higher affinity. Thus, the nitrophenol group appears to be one of the components recognized by the TRIM-containing polymer. Other factors, such as the charge and the phosphate group, may also play a role.

TABLE 3
Equilibrium Binding Constants

| “Substrate” | Polymer Component(s) | K |
|---|---|---|
| NPh | TRIM | 3.2 × 10⁴ ± 1.56 M⁻² |
| MeP | TRIM | 7.94 × 10⁶ ± 2.08 M⁻² |
| MeP | TRIM + chelator:Cu | (hydrolysis too fast |
| | | for measurement) |

The binding constants imply that there is a binding capacity associated with the polymer that is initially substrate concentration-dependent. This is verified in Table 4, where a gradual drop-off of binding capacity with decreasing initial concentrations is shown.

TABLE 4
Binding Capacity of Polymer for Methyl Parathion (MeP)

| Initial Concentration | Capacity |
|---|---|
| (mM) | (mg MeP/g polymer) |
| 0.50 | 336 ± 53 |
| 0.30 | 88 ± 21 |
| 0.10 | 53 ± 6 |

The ability of the polymer to adsorb phosphate esters may be of major consequence for the invention. In addition to an ability to quickly breakdown certain nerve agents and/or pesticides, the materials described herein can also be used to remove nerve agents or pesticides from solution/suspension in cleanup applications by adsorption on the support. The removed pesticides can then be broken down at a later time or at a different location.

### Example 17

### Preparation of Bipyridyl Coupled Polymers

Chemicals and Reagents. 4-Vinyl-4′-methyl-2,2′-bipyridine (“vbpy”) can be prepared as described in the open literature. All other reagents and solvents were purchased from commercial sources and used as received.

Cu(II)(vbpy)-TRIM polymer. Cu(NO₃)₂.2½H₂O (0.11 mmol) and 4-vinyl-4′-methyl-2,2′-bipyridine (vbpy) (0.11 mmol) were dissolved in ethanol (10 ml) and stirred for 5 minutes. TRIM (1.1 mmol) dissolved in ethanol (10 ml) was then added and argon was bubbled through the solution with stirring at room temperature for 30 minutes. The solution was heated to 70° C. and 2,2′-azobisisobutyronitrile (0.01 mmol) was added. The polymer began precipitating out of the reaction mixture after approximately 30 minutes. The reaction mixture was cooled to room temperature after 90 minutes, filtered and washed thoroughly with ethanol to give the polymer as a pale blue solid. (171 mg).

### Examples 18-20

### Preparation of Cyclononane Coupled Polymers

Cu(II)([9]aneN₃)-TRIM polymers: The procedure for making polymers that incorporate mono-, bis- and tris (4-vinyl)benzyl 1,4,7-triazacyclononane ([9]aneN₃) ligands, respectively, is as follows.

Cu(NO₃)₂.2½H₂O (0.11 mmol) and any one of the three types of vinylbenzyl-[9]aneN₃ (0.11 mmol) were dissolved in ethanol (10 ml) and stirred for 5 minutes. TRIM (1.1 mmol) dissolved in ethanol (10 ml) was then added and argon was bubbled through the solution with stirring at room temperature for 30 minutes. The solution was heated to 70° C. and 2,2′-azobisisobutyronitrile (0.01 mmol) was added. The polymer began precipitating out of the reaction mixture after approximately 30 minutes. The reaction was cooled to room temperature after 90 minutes, filtered and washed thoroughly with ethanol to give the desired polymers.

Polymers from polymerization of [9]ane(N-vinylbenzene)₃. [9]ane(Nvbz)₃ (0.69 mmol) was dissolved in ethanol (25 ml) and the solution purged with argon for 25 minutes. The solution was heated to 70° C. and 2,2′-azobisisobutyronitrile (0.05 mmol) added. After 3 hours the solution was cooled and divided in half.

i) To one half was added excess Cu(NO₃)₂.2½H₂O (0.7 mmol) dissolved in ethanol. The green solid which precipitated immediately from solution was isolated, washed with cold ethanol and air-dried to give the polymer 4 (140 mg).

ii) To the other half of the solution was added TRIM (1.1 mmol) and ethanol to make the solution volume 25 ml. This solution was purged with argon then heated 70° C. and 2,2′-azobisisobutyronitrile (0.02 mmol) was added. The polymer began precipitating out of the reaction mixture after approximately 5 minutes. The reaction mixture was cooled to room temperature after 60 minutes, filtered and washed thoroughly with ethanol. The solid was then stirred in an aqueous solution containing Cu(NO₃)₂.2½H₂O (0.7 mmol) and the resulting solid isolated, washed with water and methanol and air-dried to give the desired polymer (208 mg).

The foregoing examples have been presented for the purpose of illustration and description only and are not to be construed as limiting the invention in any way. The scope of the invention is to be determined by the claims appended hereto.

What is claimed is:

1. An immobilized catalytically active metal chelate complex which comprises a catalytically active complex of a metal ion, which is capable of hydrolyzing one or more groups selected from the group consisting of phosphate, phosphono and phosphoro groups, immobilized on a support.

2. The immobilized complex of claim 1, wherein the support is in the form of solid particles.

3. The immobilized complex of claim 2, wherein the support comprises a material selected from the group consisting of silica and chitosan.

4. The immobilized complex of claim 1, wherein the support is a porous solid material.

5. The immobilized complex of claim 1, wherein the support is in the form of a wipe, sponge or filter.

6. The immobilized complex of claim 1, wherein the support is a polymeric solid.

7. The immobilized complex of claim 1, wherein the catalytically active metal contained 15 in the immobilized metal chelate complex is selected from the group consisting of Zn(II), Cu(II), Co(III), Fe(III), Pb(III), Mg(II), Mn(III), Ni(III), La(III), Ce(III) and Eu(III).

8. The immobilized complex as claimed in claim 1, wherein the support is a self-organized polymolecular association.

9. The immobilized complex of claim 8, wherein the self-organized polymolecular association support is a support selected from the group consisting of liposomes, micelles and tubules.

10. The immobilized complex of claim 1, wherein the metal ion is complexed with a chelating agent selected from the group consisting of bipyridines, terpyridines, cyclic chelating agents, and acrylic group-containing chelating agents.

11. The immobilized complex of claim 10, wherein the metal ion is complexed with a chelating agent selected from the group consisting of 4-vinyl-4′methyl-2,2′-bipyridine, 1,4,7-triazacyclononane, 1,4,7,10-tetraazacyclododecane, tris-(3-aminopropyl)amine and analogs and derivatives of these compounds which exhibit an effective level of chelating activity to complex with the metal ion.

12. A method of making an immobilized metal chelate complex in accordance with claim 1, the method comprising the steps of:
a) providing at least one chelate which includes a chemically reactive group;
b) chemically reacting the chelate with a support utilizing the chemically reactive group contained in the chelate to form a support with the chelate covalently bonded thereto; and
c) contacting the chelate-containing support with a catalytically active metal ion to complex the catalytically active metal ion with the chelate which has been covalently bonded to the support.

13. The method of claim 12 wherein the chemically reactive group contained in the chelate is selected from the group consisting of amino groups, epoxide groups, acrylates, vinyl groups and silyl groups.

14. The method of claim 12 wherein the support is capable of adsorbing a material selected from group consisting of phosphates and phosphate esters.

15. A method of making an immobilized metal chelate complex as claimed in claim 1, the method comprising the steps of:
a) providing a first monomer comprising at least one chelate and at least one polymerizable group; and
b) polymerizing the monomer to form a polymer having a plurality of covalently bound chelate groups;
wherein one of the monomer or the polymer is contacted with a metal ion which is capable of catalyzing the hydrolysis of one or more phosphates and phosphate esters such that the resultant polymer contains a plurality of covalently bound metal chelate complexes.

16. The method of claim 15, wherein the monomer comprising at least one chelate is reacted with at least one additional monomer in step (b) to provide co-polymeric support.

17. The method of claim 16, wherein at least one of the monomers is selected so that the copolymer is capable of adsorbing compounds which contain one or more phosphate, phosphono and phosphoro groups.

18. The method of claim 15, wherein the polymerization step (b) is carried out in the presence of a compound selected from the group consisting of phosphates, phosphate esters and transition state analogs of phosphates and phosphate esters; and
further comprising the step of removing said compound from the polymer after the polymerization step (b) to provide a polymer which includes imprinted binding sites for at least one said compound.

19. The method of claim 13, wherein the monomer is selected from the group consisting of vinyl monomers and acrylic monomers.

20. The method of claim 19, wherein the monomer is selected from the group consisting of 2-ethyl-2(hydroxymethyl)propane-trimethyacrylate, divinyl benzene, acrylic acid, methacrylic acid, trifluoro-methacrylic acid, 2-vinylpyridine, 4-vinylpyridine, 3(5)-vinylpyridine, p-methylbenzoic acid, itaconic acid, 1-vinylimidazole, and mixtures thereof.

21. A method for the decontamination of a compound which contains one or more phosphate, phosphoro and phosphono groups, the method comprising the step of: contacting the compound with at least one immobilized metal chelate complex as claimed in claim 1 for a time period sufficient to hydrolyze at least some of the phosphate, phosphono or phosphoro groups in said compound.

22. The method as claimed in claim 21, wherein the immobilized metal chelate complex is immobilized on a support which is capable of adsorbing said compound and said contacting step is carried out for a time period sufficient to also permit adsorption of at least some of said compound onto the support.

23. The method as claimed in claim 22, further comprising the step of treating the support with a metal ion capable of catalyzing the hydrolysis of one or more groups selected from the group consisting of phosphate groups, phosphono groups and phosphoro groups to hydrolyze at least some of the adsorbed compound.

24. The method as claimed in claim 23, wherein the metal ion is complexed with a chelating agent selected from the group consisting of bipyridines, terpyridines, cyclic chelating agents, and acrylic group-containing chelating agents.

25. The method as claimed in claim 24, wherein the metal ion is complexed with a chelating agent selected from the group consisting of 4-vinyl-4′methyl-2,2′-bipyridine, 1,4,7-triazacyclononane, 1,4,7,10-tetraazacyclododecane, tris-(3-aminopropyl)amine and analogs and derivatives of these compounds which exhibit an effective level of chelating activity to complex with the metal ion.

26. The method as claimed in claim 24, wherein the metal ion is selected from the group consisting of Zn(II), Cu(II), Co(III), Fe(III), Pb(III), Mg(II), Mn(III), Ni(III), La(III), Ce(III) and Eu(III).

27. A method for the decontamination of a compound which contains one or more phosphate, phosphono and phosphoro groups, the method comprising the step of:
contacting the compound with at least one support that is capable of adsorbing the compound for a time period sufficient to adsorb at least some of the compound.

28. The method as claimed in claim 27, further comprising the step of treating the support containing the adsorbed compound with a metal ion capable of catalyzing the hydrolysis of a phosphate ester to hydrolyze at least some of the phosphate, phosphono or phosphoro groups in said compound.

29. The method as claimed in claim 28, wherein the metal ion is complexed with a chelating agent selected from the group consisting of bipyridines, terpyridines, cyclic chelating agents, and acrylic group-containing chelating agents.

30. The method as claimed in claim 29, wherein the metal ion is complexed with a chelating agent selected from the group consisting of 4-vinyl-4′methyl-2,2′-bipyridine, 1,4,7-triazacyclononane, 1,4,7,10-tetraazacyclododecane, tris-(3-aminopropyl)amine and analogs and derivatives of these compounds which exhibit an effective level of chelating activity to complex with the metal ion.

31. The method as claimed in claim 29, wherein the metal ion is selected from the group consisting of Zn(II), Cu(II), Co(III), Fe(III), Pb(III), Mg(II), Mn(III), Ni(III), La(III), Ce(III) and Eu(III).
